(19) United States
(12) Patent Application Publication
(10) Pub. No.: US 2018/0042026 A1
(43) Pub. Date: Feb. 8, 2018

(54) Method of Handling Uplink Buffer Status Report for Wireless Communication System

(71) Applicant: MEDIATEK INC., Hsin-Chu (TW)

(72) Inventors: Chih-Kun Chang, New Taipei City (TW); Ying-You Lin, Taoyuan City (TW)

(21) Appl. No.: 15/665,434

(22) Filed: Aug. 1, 2017

Related U.S. Application Data
(60) Provisional application No. 62/370,252, filed on Aug. 3, 2016.

(51) Int. Cl. H04W 72/08

(52) U.S. Cl. CPC H04W 72/08

(57) ABSTRACT

A method of handling an uplink (UL) bandwidth request for a station in a wireless communication system includes calculating an aggregated size by adding packet sizes of a plurality of UL packets; and transmitting a bandwidth request size to an access point of the wireless communication system; wherein the bandwidth request size is not greater than the aggregated size.

### CROSS REFERENCE TO RELATED APPLICATIONS

This application claims the benefit of U.S. Provisional Application No. 62/370,252 filed on 2016 Aug. 3, the contents of which are incorporated herein in their entirety.

### BACKGROUND

The present invention relates to a method for a wireless communication system, and more particularly, to a method of handling an uplink bandwidth request for a station in a wireless communication system.

IEEE 802.11 is a set of media access control (MAC) and physical layer (PHY) specifications for implementing wireless local area network (WLAN) communication in the unlicensed (2.4, 3.6, 5, and 60 GHz) frequency bands. The standards and amendments provide the basis for wireless network products using the unlicensed frequency bands. For example, IEEE 802.11ac is a wireless networking standard in the 802.11 family to provide high-throughput WLANs on the 5 GHz band. Significant wider channel bandwidths (20 MHz, 40 MHz, 80 MHz, and 160 MHz) were proposed in the IEEE 802.11ac standard. IEEE 802.11ax is designed for High-Efficiency WLAN (HEW) based on IEEE 802.11ac.

One key feature of IEEE 802.11ax is uplink (UL) multi-user multiple-in-multiple-out (MU-MIMO) which allows multiple users (stations) to upload data to an access point (AP) simultaneously. According to the specifications of IEEE 802.11ax, the AP transmits a trigger frame to multiple stations to inform the multiple stations of transmitting uplink (UL) data in a subsequent period at the same time. In order to effectively allocate resource units, the AP needs to acquire UL buffer statuses of the stations connected to the AP. The information of the UL buffer status transmitted by each station is undecided and is open to discussion.

### SUMMARY

In order to solve the above issue, the present disclosure provides a method of handling an uplink bandwidth request for a station in a wireless communication system.

In an aspect, the present disclosure discloses a method of handling an uplink (UL) bandwidth request for a station in a wireless communication system. The method comprises calculating an aggregated size by adding packet sizes of a plurality of UL packets; and transmitting a bandwidth request size to a peer device of the wireless communication system; wherein the bandwidth request size is not greater than the aggregated size.

In another aspect, the present disclosure discloses a method of handling an uplink (UL) bandwidth request for a station in a wireless communication system. The method comprises determining a channel condition; determining an aggregated size by adding packet sizes of a plurality of UL packets; determining that a bandwidth request size equals the aggregated size when the channel condition satisfies a channel requirement; determining the bandwidth request size by subtracting a constant size from the aggregated size when the channel condition does not satisfy the channel requirement; and transmitting the bandwidth request size to a peer device of the wireless communication system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless local area network (WLAN) communication system according to an example of the present invention.

FIG. 2 is a schematic diagram of a communication apparatus according to an example of the present invention.

FIG. 3 is a flowchart of a process according to an example of the present invention.

FIG. 4 is a timing diagram of related signals in the wireless communication system.

FIG. 5 is a timing diagram of related signals in the wireless communication system.

FIG. 6 is a timing diagram of related signals in the wireless communication system.

FIG. 7 is a timing diagram of related signals in the wireless communication system.

FIG. 8 is a flowchart of a process according to an example of the present invention.

FIG. 9 is a schematic diagram of a communication apparatus according to an example of the present invention.

### DETAILED DESCRIPTION

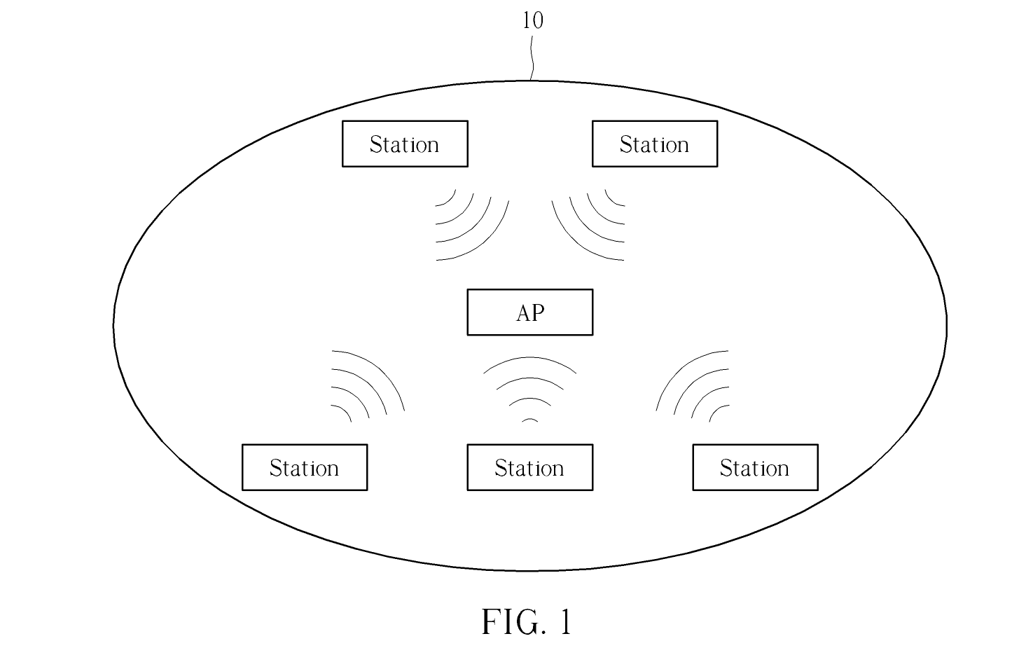

Please refer to FIG. 1, which is a schematic diagram of a wireless local area network (WLAN) communication system 10 according to an example of the present invention. The WLAN communication system 10 is briefly composed of a plurality of stations (e.g. communication devices such as smart phones, tablets, laptops, etc.), and one of the communication devices in this example, which controls communications, channel establishment, radio resource arrangement, etc. of other communication devices, is a peer device, such as an access point (AP). The AP and the stations are simply utilized for illustrating the structure of the WLAN communication system 10, which is well known in the art.

The AP and the stations may be equipped with multiple antennas for performing beamforming, to realize massive multiple-input multiple-output (MIMO) or time-reversal division multiple access (TRDMA). That is, beam sectors may be formed by the antennas according to the massive MIMO or the TRDMA. Energy of the signals (e.g., received signals and/or transmitted signals) may be separated and focused within corresponding beam sectors. The stations may be divided into multiple groups of stations, and each group of stations belongs to a corresponding one of the beam sectors. Thus, the advantage of spatial focusing effect may be provided to the stations, when the massive MIMO or the TRDMA is operated. It should be noted that complexity of a station may be further reduced if the AP performs a transmission to the station according to the TRDMA. For example, the station may need only one receive antenna to perform a reception from the network according to the TRDMA. According to the above description, multiple-user MIMO (MU-MIMO) is realized between the AP and the stations shown in FIG. 1.

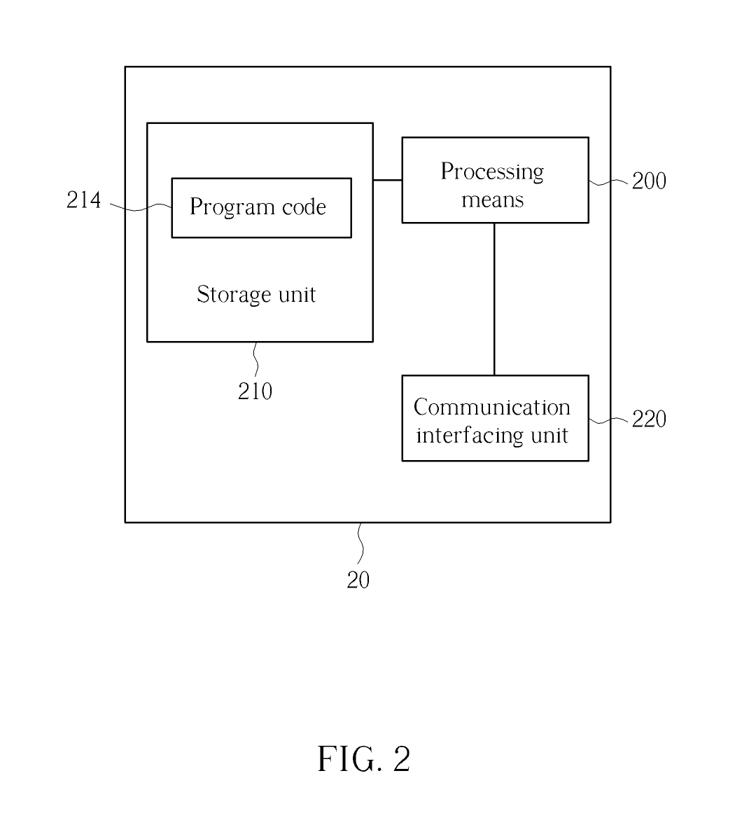

FIG. 2 is a schematic diagram of a communication apparatus 20 according to an example of the present invention. The communication apparatus 20 may be the AP or any of the stations shown in FIG. 1, but is not limited herein. The communication apparatus 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage unit, non-transitory computer-readable medium (e.g., tangible media), etc. The communication interfacing unit 220 is preferably a transceiver and is used to transmit and receive signals (e.g., data, signals, messages and/or packets) according to processing results of the processing means 200.

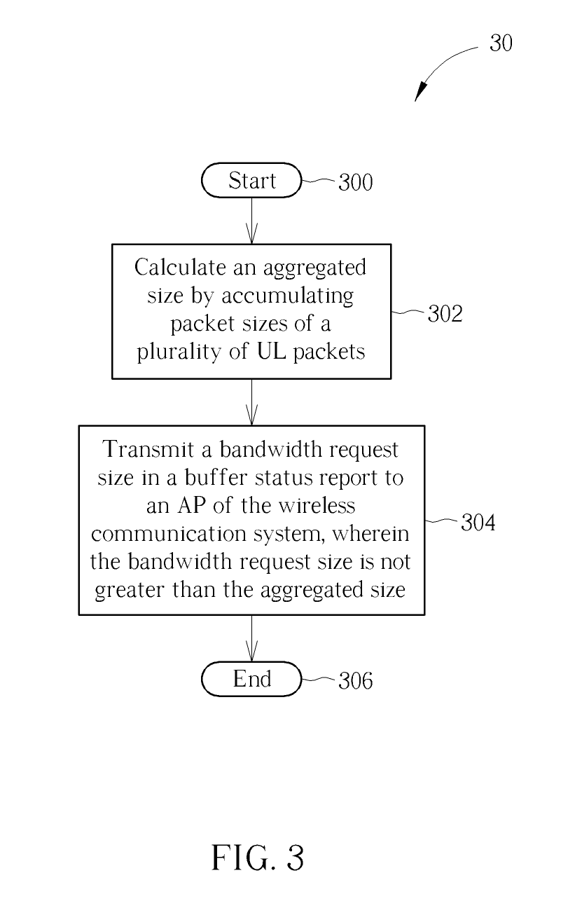

Please refer to FIG. 3, which is a flowchart of a process 30 according to an example of the present invention. The process 30 may be utilized in a station of a wireless communication system for handling an uplink (UL) buffer status report. The process 30 may be utilized in the stations shown in FIG. 1 and compiled into the program code 214. As shown in FIG. 3, the process 30 includes the following steps:

Step 300: Start.

Step 302: Calculate an aggregated size by accumulating packet sizes of a plurality of UL packets.

Step 304: Transmit a bandwidth request size in a buffer status report to an AP of the wireless communication system, wherein the bandwidth request size is not greater than the aggregated size.

Step 306: End.

According to the process 30, the station calculates an aggregated size as a reference of requesting UL resources from an AP. The aggregated size is acquired by accumulating (adding) packet sizes of a plurality of UL packets in at least one UL queue of the station. Note that, the at least one UL queue may be the UL queues corresponding to the same traffic identification (TID) or the UL queues corresponding to different access categories (AC); and the number of accumulated UL packets is the maximum number of aggregated packets corresponding to a block acknowledge (BA) window and is limited by the size of the BA window. In an example, the maximum aggregation number may be 32 or 64 and the station selects 32 or 64 UL packets from the at least one UL queue and adds the packet sizes of the selected 32 or 64 UL packets as the aggregated size. When receiving a trigger frame of informing the station to transmit UL data from the AP, the station transmits a bandwidth request size that is not greater than the aggregated size in a buffer status report to request UL resource for transmitting the selected UL packets. In an example, the buffer status report is transmitted in a high-efficient (HE) variant high-throughput (HT) control field. As a result, the AP acknowledges the actual size of the UL packets arranged to be transmitted in the next BA window of each station and is able to accordingly arrange adequate UL resources for the stations connected to the AP.

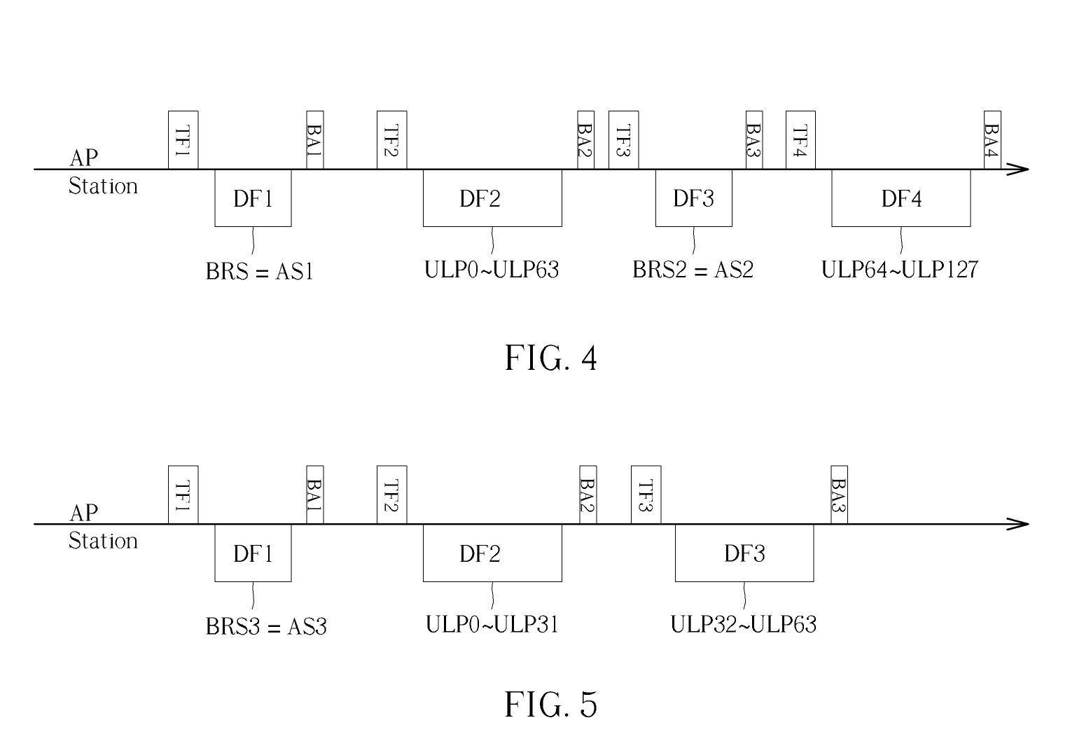

Please refer to FIG. 4, which is a timing diagram of related signals in the wireless communication system. In FIG. 4, the AP transmits a trigger frame TF1 to the station, to ask the station to transmit UL data. After receiving the trigger frame TF1, the station calculates an aggregated size AS1 as the reference of requesting UL resources. In this example, the UL queues of the station comprise UL packets ULP0-ULP127 and the maximum number of aggregated packets in the BA window is 64. Thus, the station adds the packets sizes of the UL packets ULP0-ULP63 as the aggregated size AS1. In this example, the packet sizes of the UL packets ULP0-ULP163 are all 1.5k bytes and the aggregated size AS1 is 96k

$$( i . e . {\sum }_{i = 0}^{63} ULPi = 64 \times 1.5 k )$$

bytes. Next, the station transmits a data frame DF1 comprising bandwidth request size BRS1 in the buffer status report to the AP. In this example, the bandwidth request size BRS1 equals the aggregated size AS1. Note that, the data frame DF1 may be a quality of service (QoS) NULL frame and the bandwidth request size BRS1 may be configured in the QoS control field. After receiving the data frame DF1, the AP accordingly transmits a BA frame BA1 to the station. Based on the bandwidth request size BRS1, the AP arranges the UL resources in a trigger frame TF2, to make the station transmit all of the UL packets ULP0-ULP63 in the same BA window, and the AP accordingly transmits the BA frame BA2 to the station.

According to the BA frame BA2, the station acknowledges that all of the UL packets ULP0-ULP63 are successfully transmitted and transmits another bandwidth request size BRS2 in a data frame DF3 after receiving a trigger frame TF3. In this example, the bandwidth request size BRS2 also equals an aggregated size AS2 that is acquired by adding packet sizes of the UL packets ULP64-ULP127. In this example, the packet sizes of the UL packets ULP64-ULP127 are all 1k bytes and the aggregated size AS2 is 64k

$$( i . e . {\sum }_{i = 64}^{127} ULPi = 64 \times 1 k )$$

bytes. Based on the bandwidth request size BRS2, the AP arranges adequate UL resources in a trigger frame TF4, to make the station transmit all of the UL packets ULP64-ULP127 in the same BA window, and the AP accordingly transmits the BA frame BA4 to the station. Because the bandwidth request size BRS2 is smaller than the bandwidth request size BRS1, the AP may arrange less UL resources to the station for transmitting the UL packets ULP64-ULP127. That is, the AP is able to arrange the UL resources based on actual size of the UL packets arranged to be transmitted in the next BA window. The efficiency of allocating the UL resources is improved, therefore.

Please refer to FIG. 5, which is a timing diagram of related signals in the wireless communication system. Similarly, the AP transmits the trigger frame TF1 to the station. The station calculates an aggregated size AS3 for determining a bandwidth request size BRS3. In this example, the UL queues of the station comprise UL packets ULP0-ULP63 whose packet sizes are 1.5k bytes and the maximum number of aggregated packets in the BA window is 64. Thus, the station accumulates the packet sizes of the UL packets ULP0-ULP63 as the aggregated size AS3 and transmits a bandwidth request size BRS3 equal to the aggregated size SS3 in the data frame DF1. Different from the AP in FIG. 4, the AP in this example allocates UL resources for respectively transmitting 48k (i.e. 32*1.5k bytes) bytes to the station in subsequent two BA windows. Under such a condition, the station transmits the UL packets ULP0-ULP31 after receiving the trigger frame TF2 and transmits the UL packets ULP32-ULP63 after receiving the trigger frame TF3. After receiving the BA frames BA2 and BA3 and determining the UL packets ULP0-ULP63 are transmitted successfully, the station is able to transmit another bandwidth request size when receiving another trigger frame from the AP, to require UL resources of transmitting UL data.

As can be seen from the above examples, the station is required to acknowledge whether the transmission of UL packets successes according to the BA frames before requesting the UL resources of transmitting subsequent UL packets. In order to improve the efficiency of transmitting UL data to the AP, the station may predict the bandwidth request size based on at least one channel condition between the AP and the station and the aggregation size of the UL packets that are planned to be transmitted in subsequent BA window. In an example, the station first collects the at least one channel condition, such as packet error rate (PER) and bit error rate (BER), and calculates the aggregated size by accumulating of the packet sizes of the UL packets in at least one UL queue of the station. Next, the station determines whether the at least one channel condition satisfies at least one channel requirement, to determine the bandwidth request size in the UL buffer status report. When the at least one channel condition satisfies at least one channel requirement (e.g. PER is smaller than a threshold), the station determines the channel condition is great and predicts that the UL packets would be transmitted successfully. Under such a condition, the station directly utilizes the aggregated size as the bandwidth request size. If the at least one channel condition does not satisfy the at least one channel requirement, the station determines that current channel condition is not suitable for aggregating the maximum number of UL packets in single BA window. Thus, the station determines the bandwidth request size by subtracting a constant size from the aggregated size and transmits the bandwidth request size with the UL packets. After determining the bandwidth request size, the station transmits the bandwidth request size with the UL packets corresponding to previous bandwidth request size to require the UL resources for subsequent UL packets. As a result, the station is able to reduce the latency of requesting UL resources by predicting the bandwidth request size.

Please refer to FIG. 6, which is a timing diagram of related signals in the wireless communication system. As shown in FIG. 6, the AP transmits the trigger frame TF1 to the station. The station calculates an aggregated size AS4 for determining a bandwidth request size BRS4. In this example, the UL queues of the station comprise the UL packets ULP0-UKP127 whose packet sizes are 1.5k bytes and the maximum number of aggregated packets in the BA window is 64. Because the station does not know the channel conditions before receiving the BA frame BA1, the station determines that the bandwidth request size BRS4 equals the aggregated size AS4 (i.e. 64*1.5k bytes). Next, the station receives the BA frame BA1 and determines that PER is 0. Because the PER is smaller than 1% (i.e. channel requirement is whether the PER is smaller than 1%), the station calculates an aggregated size AS5 by accumulating packet sizes of the UL packets ULP64-ULP127 and utilizes the aggregated size AS5 as the bandwidth request size BRS5. When transmitting UL packets ULP0-ULP63 after receiving the trigger frame TF2, the station transmits the bandwidth request size BRS5 in the UL buffer status report. As a result, the station is able to transmit the UL packets ULP64-ULP127 in next BA window. By predicting the bandwidth request size, the efficiency of transmitting UL data is improved.

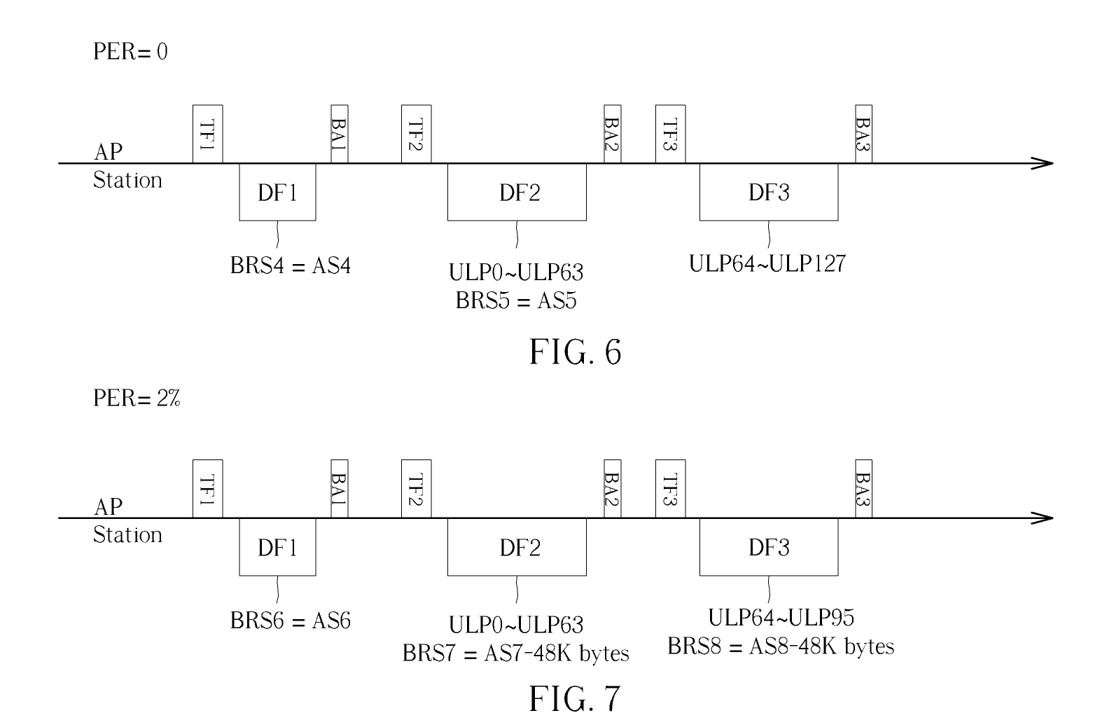

Please refer to FIG. 7, which is a timing diagram of related signals in the wireless communication system. As shown in FIG. 7, the AP transmits the trigger frame TF1 to the station. The station calculates an aggregated size AS6 for determining a bandwidth request size BRS6. In this example, the UL queues of the station comprise the UL packets ULP0-UKP191 whose packet sizes are 1.5k bytes and the maximum number of aggregated packets in the BA window is 64. Because the station does not know the channel condition before receiving the BA frame BA1, the station determines that the bandwidth request size equals the aggregated size AS6 (i.e. 64*1.5k bytes). According to the BA frame BA1, the station acknowledges the PER is 2% that is greater than 1%. Because the channel condition does not satisfy the channel requirement, the station calculates an aggregated size AS7 by accumulating packet sizes of the UL packets ULP64-ULP127 and subtracting 48k bytes (i.e. the constant size) from the aggregated size AS7 to determine a bandwidth request size BRS7. When transmitting the UL packets ULP0-ULP63, the station transmits the bandwidth request size BRS7 in the UL buffer status report to request the UL resources of transmitting the UL packets ULP64-ULP95. Because of predicting the bandwidth request size based on the channel condition and the aggregated size, the station is able to transmit the UL packets ULP64-ULP95 in the next BA window. Similarly, the station transmits a bandwidth request size BRS8 that equals the difference between an aggregated size AS8 and 48k bytes, in the buffer status report when transmitting the UL packets ULP64-ULP95. By predicting the bandwidth request size, the efficiency of transmitting UL data is improved.

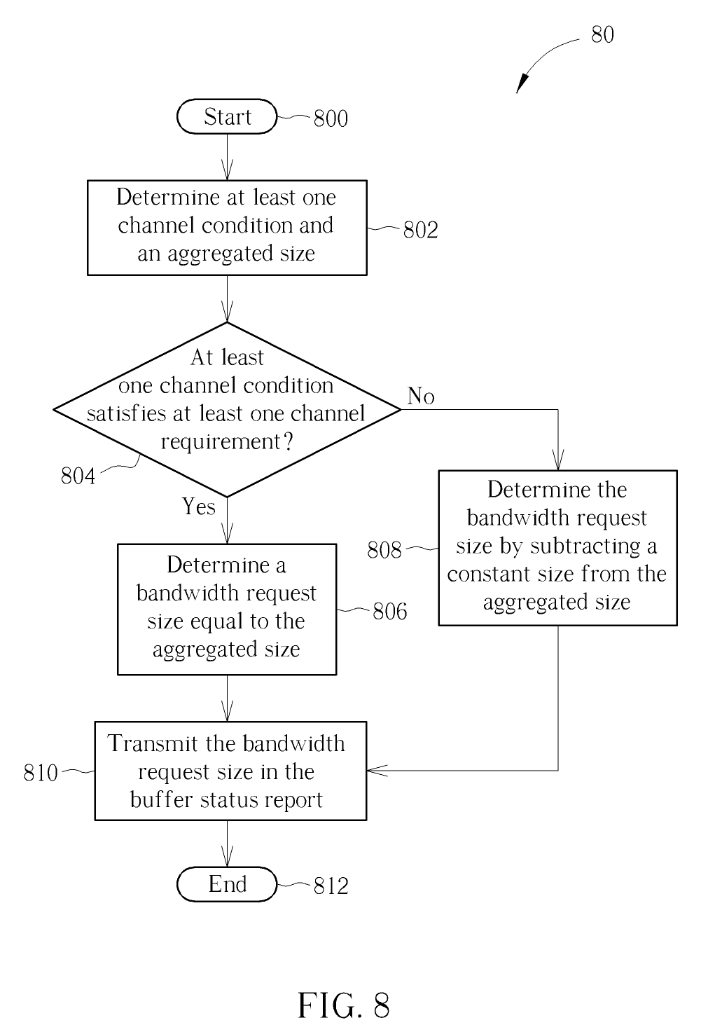

The process of the station determining the bandwidth request size in the above examples can be summarized into a process 80 shown in FIG. 8. The process 80 may be utilized in a station of a wireless communication system for determining a bandwidth request size in a UL buffer report. The process 80 may be utilized in the stations shown in FIG. 1 and compiled into the program code 214. As shown in FIG. 8, the process 80 includes the following steps:

Step 800: Start.

Step 802: Determine at least one channel condition and an aggregated size.

Step 804: Determine whether the at least one channel condition satisfies at least one channel requirement. If the at least one channel condition satisfies the at least one channel requirement, perform step 806; otherwise, perform step 808.

Step 806: Determine that a bandwidth request size equals the aggregated size.

Step 808: Determine the bandwidth request size by subtracting a constant size from the aggregated size.

Step 810: Transmit the bandwidth request size in the UL buffer status report.

Step 812: End.

According to the process 80, the station determines at least one channel condition and an aggregated size. For example, the channel condition may comprise PER and BER between the AP and the station and the aggregated size is acquired by accumulating packets size of a plurality of UL packets. The number of accumulated UL packets is the maximum number of packets corresponding to the BA window and is limited by the BA window size. Next, the station determines whether the at least one channel condition satisfies at least one channel requirement, to determine a bandwidth request size. For example, the at least one channel requirement may be whether the PER is smaller than a threshold hold. If the at least one channel condition satisfies the at least one channel requirement, the bandwidth size equals the aggregated size; otherwise, the bandwidth size is acquired by subtracting a constant size from the aggregated size. After determining the bandwidth request size, the station transmits the bandwidth request size in the buffer status report, to request UL resources of transmitting the plurality of UL packets.

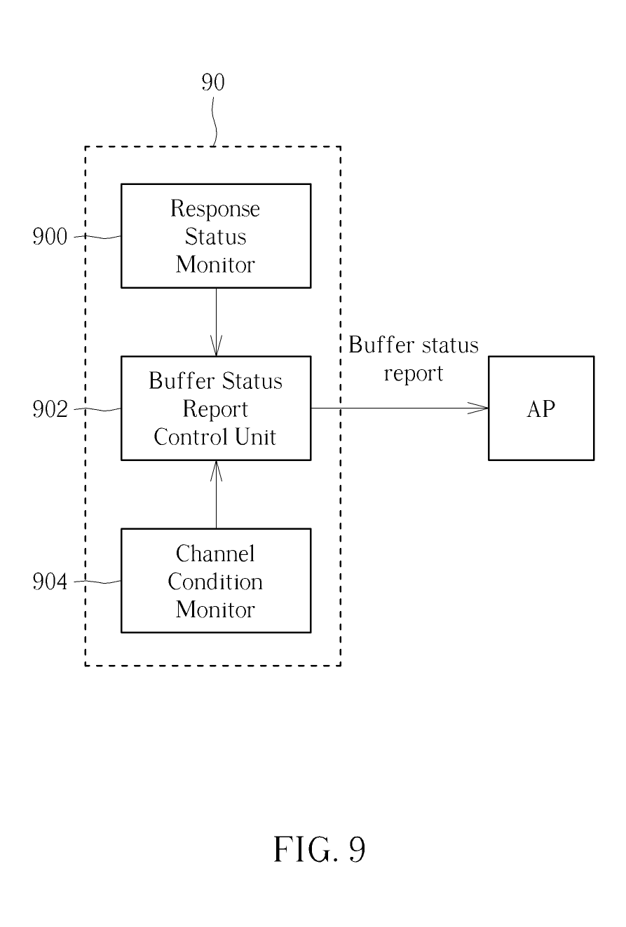

Those skilled in the art should readily make combinations, modifications and/or alterations on the abovementioned description and examples. In addition, the abovementioned description, steps and/or processes including suggested steps can be realized by means that could be hardware, software, firmware (known as a combination of a hardware device and computer instructions and data that reside as read-only software on the hardware device), an electronic system, or combination thereof. For example, the means may be the communication apparatus 20 shown in FIG. 2 or a communication apparatus 90 shown in FIG. 9. In the example shown in FIG. 9, the communication apparatus 90 comprises a response status monitor 900, a buffer status report control unit 902 and a channel condition monitor 904. The response status monitor 900 is utilized to provide the maximum BA window size to the buffer status report control unit 902 and the channel condition monitor 904 is utilized to provide at least one channel condition between the AP and the communication apparatus 90 to the buffer status report control unit 902. The buffer status report control unit 902 calculates the aggregated size by accumulating packet sizes of the UL packets, wherein the number of the accumulated UL packets is the maximum number of packets aggregated in the BA window determined by the maximum BA window size, and determines the bandwidth request size in the buffer status report according to the aggregated size and the at least one channel condition. The detailed operations of the communication apparatus 90 can be referred to the above and are not described herein for brevity.

The processes of the present disclosure calculate actual size of the UL packets aggregated in single BA window as the reference of requesting UL resources. By adopting the processes of the present disclosure, the AP is able to allocate UL resources more efficiently. Furthermore, the station may predict bandwidth request size based on the channel conditions. The efficiency of UL transmissions is further improved, therefore.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling an uplink (UL) bandwidth request for a station in a wireless communication system, comprising:
calculating an aggregated size by adding packet sizes of a plurality of UL packets; and
transmitting a bandwidth request size to a peer device of the wireless communication system;
wherein the bandwidth request size is not greater than the aggregated size.

2. The method of claim 1, wherein a number of added UL packets is the maximum number of packets corresponding to a block acknowledge window.

3. The method of claim 1, wherein the bandwidth request size is in a buffer status report transmitted in a high-efficient variant high-throughput control field.

4. The method of claim 1, further comprising:
determining a channel condition; and
adjusting the bandwidth request size according to the channel condition.

5. The method of claim 4, wherein the bandwidth request size is adjusted to the aggregated size when the channel condition satisfies a channel requirement.

6. The method of claim 4, wherein the bandwidth request size is adjusted to be a difference between the aggregated size and a constant size.

7. The method of claim 1, wherein the peer device is an access point.

8. A method of handling an uplink (UL) bandwidth request for a station in a wireless communication system, comprising:
determining a channel condition;
determining an aggregated size by adding packet sizes of a plurality of UL packets;
determining that a bandwidth request size equals the aggregated size when the channel condition satisfies a channel requirement;
determining the bandwidth request size by subtracting a constant size from the aggregated size when the channel condition does not satisfy the channel requirement; and
transmitting the bandwidth request size to a peer device of the wireless communication system.

9. The method of claim 8, wherein a number of added UL packets is the maximum number of packets corresponding to a block acknowledge window.

10. The method of claim 8, wherein the bandwidth request size is in a buffer status report transmitted in a high-efficient variant high-throughput control field.

11. The method of claim 8, wherein the channel condition is packet error rate and the channel requirement is whether the packet error rate is below a threshold.

12. The method of claim 8, wherein the peer device is an access point.
